(19) United States
(12) Patent Application Publication
(10) Pub. No.: US 2013/0001343 A1
(43) Pub. Date: Jan. 3, 2013

(54) RECORDING TAPE CARTRIDGE

(75) Inventors: Yosuke Sumiya, Kanagawa (JP); Kazuo Hiraguchi, Kanagawa (JP)

(73) Assignee: FUJIFILM CORPORATION, Minato-ku, Tokyo (JP)

(21) Appl. No.: 13/583,930

(22) PCT Filed: Jan. 17, 2011
(86) PCT No.: PCT/JP2011/050677

§ 371 Date: Sep. 11, 2012

(30) Foreign Application Priority Data
Mar. 15, 2010 (JP) 2010-058153

(51) Int. Cl. G11B 23/107

(52) U.S. Cl. 242/348

(57) ABSTRACT

A recording tape cartridge capable of lessening limitations to the length of a security tag to be installed in a case is obtained. A recording tape cartridge includes a reel on which a magnetic tape T is wound, a case housing the reel between a top plate and a bottom plate that face each other along a reel axial direction, and at the inside of peripheral walls, a reel area rib covering the outer periphery of the reel at least at a corner portion of the case, and a security tag that is disposed in a space with a substantially right-angled triangle shape in plan view surrounded by a front wall, a left side wall and the reel area rib inner wall at the corner portion of the peripheral walls, such that a length direction of the security tag runs along the reel area rib in plan view.

### TECHNICAL FIELD

The present invention relates to a recording tape cartridge including a security tag installed in a case.

### BACKGROUND ART

Tape cartridges are known in which a security tag is retained with respect to a case body by a holder (see for example Japanese Patent Application Laid-Open (JP-A) No. 2009-129531). In this configuration a holder, retaining a security tag formed in a circular column shape, contacts with a bottom plate, a top plate, a side plate and a partitioning plate of a case body, such that the axial direction of the security tag is parallel to the axial direction of a reel.

### DISCLOSURE OF INVENTION

### Subject to be Addressed

However in the above technology, the security tags that can be installed in the case are limited to small security tags, and there is room for improvement from the perspective of raising communication performance.

The present invention is directed towards a recording tape cartridge having less limitations to the length of a security tag to be installed in a case.

### Solution to Subject

A recording tape cartridge according to a first aspect of the present invention includes: a reel on which magnetic tape is wound; a case housing the reel between a top plate and a bottom plate that face each other along a reel axial direction, at the inside of a peripheral wall connecting peripheral edge portions of the top plate and the bottom plate; an inner wall provided so as to extend out from at least one of the bottom plate or the top plate so as to cover the outer periphery of the reel at least at a corner portion of the case; and a security tag that is disposed in a space surrounded by two sides of the peripheral wall forming the corner portion of the case and the inner wall, such that a length direction of the security tag runs along the inner wall as viewed in the reel axial direction.

According to the above aspect, at least at the corner portion of the case, the reel is covered from the outer periphery side by the inner wall provided at the inside of the peripheral wall. The space of the corner portion of the case is formed in a substantially right angled triangle shape surrounded by the two sides of the peripheral wall and the inner wall as viewed in the reel axial direction. The security tag is disposed along the inner wall corresponding to the diagonal side of the right angled triangle, whereby a long placement space can be achieved for the security tag. A security tag that is longer in its longitudinal direction can accordingly be installed than a security tag which is configured to be disposed, for example, along the peripheral wall.

The recording tape cartridge of the above aspect accordingly enables restrictions on the length of the security tag to be installed in the case to be lessened. Arrangements of the security tag of the first aspect wherein the security tag is disposed lengthwise along the inner wall include the following arrangement. For example, when the inner wall is configured in a curve as viewed in the reel axial direction, if a straight line approximation is made for the inner wall, the security tag is disposed such that the length direction of the security tag is along a direction substantially parallel to the straight line (or at least a direction not parallel to the peripheral walls).

The recording tape cartridge of the above aspect may be configured such that: the case is configured from an upper case, with an upper peripheral wall provided to extend out from a peripheral edge portion of the top plate to configure an upper portion of the peripheral wall, and a lower case, with a lower peripheral wall provided to extend out from a peripheral edge portion of the bottom plate to configure a lower portion of the peripheral wall, by placing the upper peripheral wall and the lower peripheral wall in contact with each other and joining them together; and the security tag is disposed along the portion where the upper peripheral wall and the lower peripheral wall make contact with each other.

According to the above aspect, the security tag is disposed along the portion where the upper peripheral wall of the upper case and the lower peripheral wall of the lower case make contact with each other. The security tag can thereby be disposed without interfering for example with structural portions of the case provided on the top plate side or on the bottom plate side.

In the recording tape cartridge of the above aspect, a pocket shaped protrusion covering a reference hole open in the bottom plate projects out into the lower case from the bottom plate, and the security tag is disposed between the protrusion and the top plate.

According to the above aspect, the security tag is disposed between the protrusion projecting out from the bottom plate and the top plate and along the contact portions between the upper peripheral wall and the lower peripheral wall. The security tag can thereby be disposed without interfering with the protrusion. In other words, the space including the region overlapping with the protrusion in plan view is used effectively, enabling a long security tag to be disposed.

In the recording tape cartridge of the above aspect, a low portion that forms a bottom portion of an indentation employed to prevent incorrect insertion into a drive device is formed to the top plate of the upper case, and the security tag is disposed between the low portion and the bottom plate.

According to the above aspect, the security tag is disposed between the bottom plate and the low portion of the top plate along the contact portions between the upper peripheral wall and the lower peripheral wall. The security tag can accordingly be disposed without interfering with the low portion. In other words, the space including the region overlapping with the low portion in plan view is used effectively, enabling a long security tag to be disposed.

The recording tape cartridge of the above aspect further includes a retaining member that retains the security tag with respect to the case.

According to the above aspect, the security tag can be retained with respect to the case by the retaining member.

In the recording tape cartridge of the above aspect, the security tag is retained with respect to the case by the security tag being interposed in the reel axial direction between a configuration portion of the upper case and a configuration portion of the lower case.

According to the above aspect, the security tag is retained with respect to the case by the security tag being interposed between the upper case and the lower case. The security tag can thereby be retained by the case without using a separate component.

In the recording tape cartridge of the above aspect, a length in the longitudinal direction of the security tag is set longer than the maximum separation in the case along the reel axial direction between the top plate and the bottom plate.

According to the above aspect, a security tag that is longer than the maximum separation between the top plate and the bottom plate can be installed due to a structure in which the security tag is disposed along the inner wall.

### Advantageous Effects of Invention

The recording tape cartridge according to the present invention as explained above exhibits the excellent advantageous effect of enabling the limitations to the length of a security tag to be installed in a case to be lessened.

### BRIEF DESCRIPTION OF DRAWINGS

FIG. 1 is a perspective view illustrating relevant portions of a recording tape cartridge according to a first exemplary embodiment of the present invention;

FIG. 2A is a plan view illustrating relevant portions of a recording tape cartridge according to the first exemplary embodiment of the present invention;

FIG. 2B is a cross-section taken along line 2B-2B of FIG. 2A and illustrating relevant portions of a recording tape cartridge according to the first exemplary embodiment of the present invention;

FIG. 3 is a perspective view illustrating the external appearance of a recording tape cartridge according to the first exemplary embodiment of the present invention;

FIG. 4 is an exploded perspective view illustrating a recording tape cartridge according to the first exemplary embodiment of the present invention, as seen from above;

FIG. 5 is an exploded perspective view illustrating a recording tape cartridge according to the first exemplary embodiment of the present invention, as seen from below;

FIG. 6A is a perspective view illustrating relevant portions of a structure of a recording tape cartridge according to the first exemplary embodiment of the present invention, illustrating relevant portions of the lower case alone;

FIG. 6B is a perspective view illustrating relevant portions of a structure of a recording tape cartridge according to the first exemplary embodiment of the present invention, illustrating relevant portions of the upper case alone;

FIG. 7 is a perspective view illustrating relevant portions of a recording tape cartridge according to a second exemplary embodiment of the present invention;

FIG. 8 is a plan view illustrating relevant portions of a recording tape cartridge according to the second exemplary embodiment of the present invention;

FIG. 9 is a perspective view illustrating relevant portions of a recording tape cartridge according to a third exemplary embodiment of the present invention; and

FIG. 10 is a perspective view illustrating a retaining member configuring a recording tape cartridge according to the third exemplary embodiment of the present invention.

### BEST MODE FOR CARRYING OUT THE INVENTION

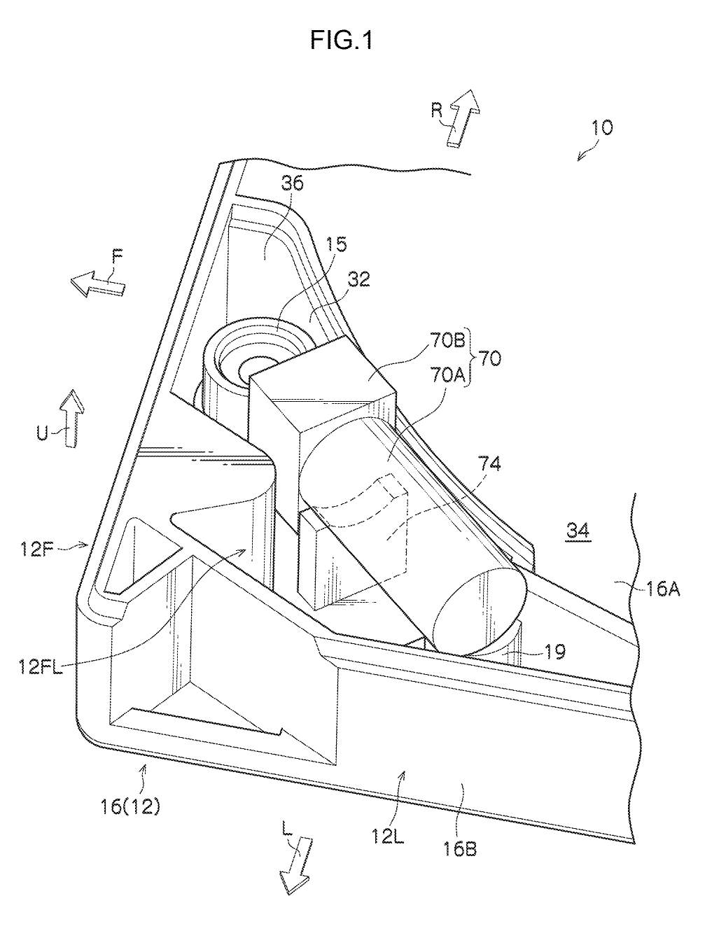

Explanation follows regarding a recording tape cartridge 10 according to a first exemplary embodiment of the present invention, with reference to FIG. 1 to FIG. 7. Explanation will first be given regarding the overall configuration of the recording tape cartridge 10, followed by explanation of a case installation structure for a security tag 70 installed in the recording tape cartridge 10. Note that in the following explanation, where appropriate the arrow U direction in each of the drawings is referred to as the up direction, the arrow F direction as the front direction (the loading direction in a drive device), the arrow R direction as the right direction, and the arrow L direction as the left direction. However, these directions are not limitations to the orientation of the recording tape cartridge 10.

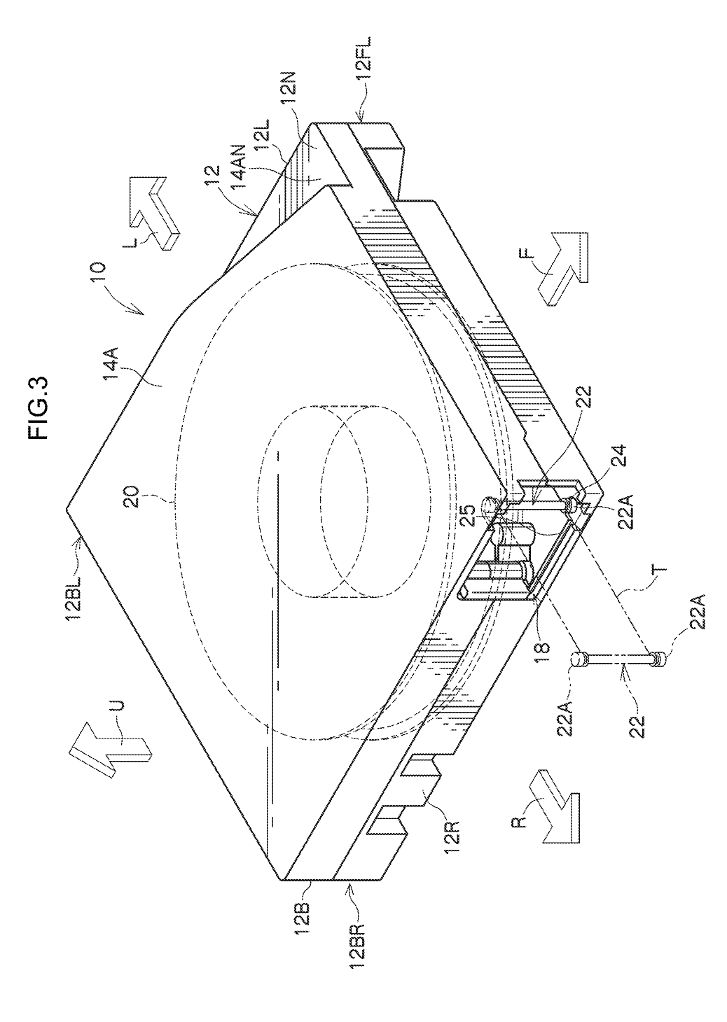

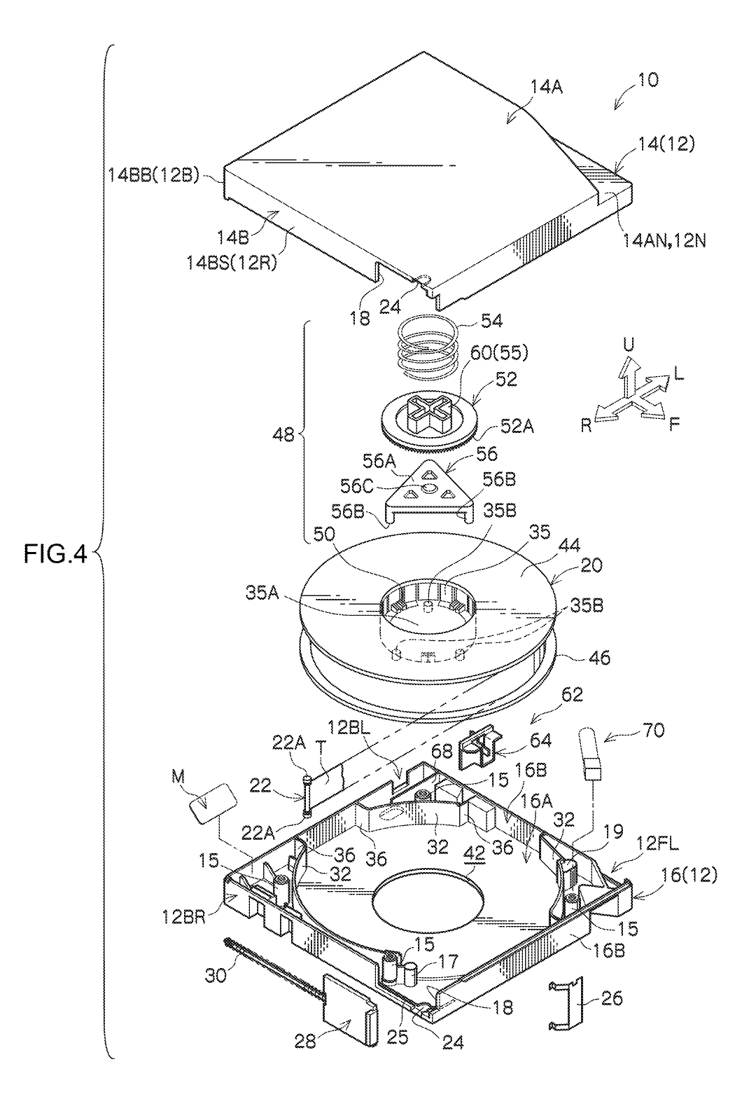

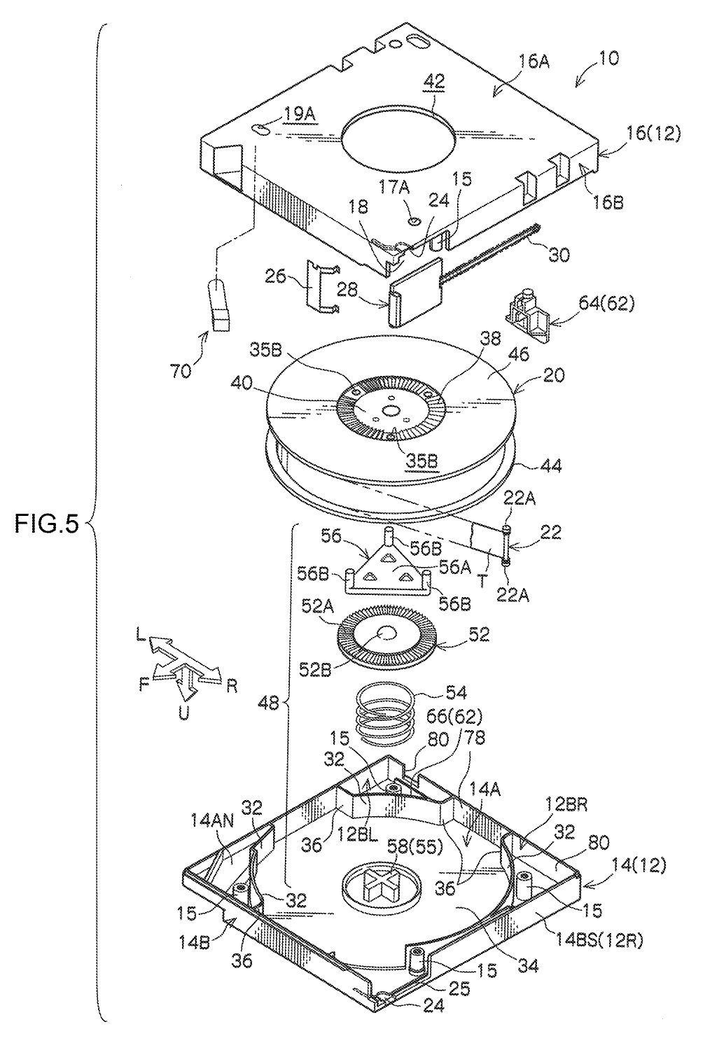

FIG. 3 is a perspective view of the external appearance of the recording tape cartridge 10. FIG. 4 is an exploded perspective view of the recording tape cartridge 10 as seen from above, and FIG. 5 is an exploded perspective view of the recording tape cartridge 10 as seen from below. As shown in these drawings, the recording tape cartridge 10 is equipped with a case 12. The case 12 is configured by aligning the opening edge of a resin upper case 14 opening downwards together with the opening edge of a resin lower case 16 opening upwards, and joining the opening edges together. In the present exemplary embodiment, the case 12 has a substantially rectangular shape (square shape) in plan view and is also configured as a flat case that is thin in the top-bottom direction.

Specifically, the upper case 14 is formed with a top plate 14A that is substantially rectangular shaped in plan view, with an outer peripheral wall 14B that serves as a peripheral wall or upper peripheral wall extending downwards from peripheral edge portions of the top plate 14A. The lower case 16 is formed with a bottom plate 16A that is substantially rectangular shaped in plan view, with an outer peripheral wall 16B that serves as a peripheral wall or a lower peripheral wall extending upwards from peripheral edge portions of the bottom plate 16A. The case 12 is configured by joining the upper case 14 and the lower case 16 in a state in which the opening edges of the outer peripheral wall 14B and the opening edges of the outer peripheral wall 16B abut each other. In the present exemplary embodiment, screw bosses 15 projecting out from the top plate 14A of the upper case 14 and the bottom plate 16A of the lower case 16 contact with each other, and a threaded portion of screws (not shown in the drawings) whose heads are housed inside the bottom screw bosses 15 are screwed into the upper screw bosses 15. The upper case 14 and the lower case 16 are thereby joined together.

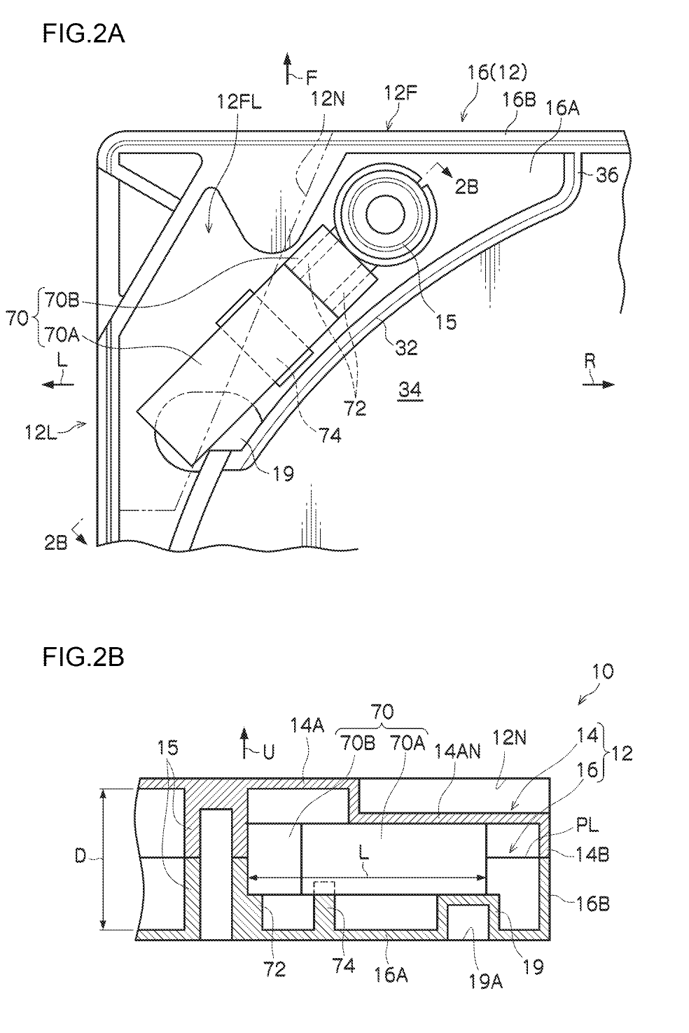

Hence the case 12 is formed with a peripheral wall of the outer peripheral wall 14B and the outer peripheral wall 16B connecting together the outer peripheral portion of the top plate 14A and the outer peripheral portion of the bottom plate 16A. The portion where the outer peripheral wall 14B and the outer peripheral wall 16B make contact with each other, namely the boundary portion, configures a parting line PL (see FIG. 3). Note that the parting line PL, as shown in FIG. 2B, further configures the boundary portion of upper and lower screw bosses 15 and a reel area rib 32 (described later).

A single reel 20 wound with a magnetic tape T, serving as a recording tape, is rotatably housed inside the case 12. The magnetic tape T wound on the reel 20 is configured so as to be pulled out to the outside of the case 12 through an opening 18 formed at a front end side of a right sidewall 12R of the case 12 when the case 12 is accommodated inside a drive device, not shown in the drawings. Configuration is such that reading and writing of data is made to the magnetic tape T pulled out from the case 12 through the opening 18.

A pair of reference holes 17A, 19A (see FIG. 4) is opened at the front end side (the opening 18 placement side) of the outside face of the bottom plate 16A of the case 12. The pair of reference holes 17A, 19A is provided inside pocket shaped protrusions 17, 19 (see FIG. 5) serving as protrusion portions extending from the bottom plate 16A into the case 12. The reference holes 17A, 19A are disposed separated from each other along an imaginary line orthogonal to the direction of loading into the drive device (the arrow F direction). Viewed from the bottom, the reference hole 17A at the side close to the opening 18 is formed with a substantially square shape that circumscribes a positioning pin of the drive device, and the reference hole 19A is an elongated hole extending lengthwise along the imaginary line referred to above, with a width corresponding to the diameter of a positioning pin.

Configuration is thereby made such that the recording tape cartridge 10 is accurately positioned in the horizontal direction (left-right and front-back) inside the drive device when the recording tape cartridge 10 has been loaded into the drive device and the respective positioning pins have been inserted into the respective reference holes 17A, 19A.

A notch portion 12N is also formed at a left hand side corner portion 12FL on the opposite side of the front edge portion of the case 12 to the opening 18 side, as an indentation where the top plate 14A is provided with a step lower than at other portions. The notch portion 12N is configured to function as a determination portion to stop incorrect insertion of the recording tape cartridge 10 into the drive device. The portion of the top plate 14A configuring the bottom portion of the notch portion 12N is a low portion 14AN.

A leader pin 22 is attached to the leading end of the magnetic tape T and serves as a lead member that is manipulated (retained) when the magnetic tape T is being pulled out by the drive device. Flanges 22A, formed at both ends of the leader pin 22 and projecting out from the magnetic tape T width direction end portions, are inserted into pin receiving indentations 24 provided at a position facing towards the opening 18 of the case 12. The leader pin 22 is accordingly retained in specific position with respect to the case 12. A spring 26 is provided to the case 12 to hold the orientation of the leader pin 22 with respect to the case 12 by pressing the flanges 22A into the indentation walls of the pin receiving indentations 24. A thin shaft portion of the leader pin 22 between the flanges 22A and the magnetic tape T is hooked by a pulling out member of the drive device so as to be pulled out from the case 12 together with the magnetic tape T.

The opening 18 of the case 12 is configured to be opened or closed by a door 28 serving as an opening and closing member. The door 28 is configured to open or close the opening 18 by sliding in a front-rear direction while being guided in a guide groove 25 formed along a right side wall 12R configured by the outer peripheral wall 14B and the outer peripheral wall 16B. The door 28 is biased by a door spring 30 in the direction to close the opening 18.

Reel area ribs 32 extend out from the case 12 and serve as an inner wall that is an upright wall portion provided so as to cover the reel 20 from the radial direction outside (external peripheral side). The reel area ribs 32 are configured by joining together two halves that respectively extend out from the top plate 14A and the bottom plate 16A. The reel area ribs 32 are configured to surround a reel space 34 in which the reel 20 is disposed. There are plural of the reel area ribs 32 provided in the present exemplary embodiment extending out at portions along the peripheral direction. The respective peripheral direction end portions of the reel area ribs 32 are connected to the outer peripheral wall 14B or the outer peripheral wall 16B through connection walls 36 serving as an inner wall. In order to form the guide groove 25, the connection wall 36 is not connected at the peripheral end portion of the reel area ribs 32 positioned in the vicinity of the opening 18, but the screw bosses 15 is integrated thereto to secure strength.

A reel opening 42 is formed in a substantially central position in the bottom plate 16A of the case 12, in order to expose a reel gear 38, provided to a bottom portion 35A of a reel hub 35 configuring an axial center portion of the reel 20, and a reel plate 40 that is formed from a metal with magnetic properties. A rotation shaft, not shown in the drawings, of the drive device meshes a drive gear with the reel gear 38 while attracting and retaining the reel plate 40 using a magnet, so as to drive rotation of the reel 20.

The reel 20 has a top and bottom pair of flanges 44, 46 that restrict width direction misalignment of the magnetic tape T wound on the outer peripheral face of the reel hub 35. Namely, the magnetic tape T is wound between the flanges 44, 46. A lock mechanism 48 is provided inside the circular cylindrical shaped portion of the reel hub 35 for locking or releasing locking of rotation of the reel 20 with respect to the case 12.

The lock mechanism 48 is configured with main portions including: an upwards facing engagement gear 50 provided on the top face side of the bottom portion 35A of the reel hub 35; a brake member 52 including a downwards facing brake gear 52A capable of meshing with the engagement gear 50; a rotation prevention section 55 that prevents rotation of the brake member 52 with respect to the case 12; a locking spring 54 that biases the brake member 52 downwards to mesh the brake gear 52A with the engagement gear 50; and a release operation member 56 for pushing up the brake member 52 against the biasing force of the locking spring 54.

The rotation prevention section 55 is configured so as to be capable of inserting a cross-shaped rib 58 projecting out from the top plate 14A into a cross-shaped groove 60 of the brake member 52, by relative displacement in the up-down direction. The release operation member 56 is disposed between the bottom portion 35A and the brake member 52, and is configured such that by moving upwards, the brake member 52 is moved towards the top side so as to release the meshing of the engagement gear 50 with the brake gear 52A, namely to release the rotation locked state of the reel 20.

In the present exemplary embodiment, leg portions 56B of the release operation member 56, projecting down from each apex of a body 56A formed substantially triangular in plan view, pass through through holes 35B in the bottom portion 35A. The leg portions 56B project out between the teeth of the reel gear 38, and are configured to be pressed and moved upwards by the drive gear of the rotation shaft meshing with the reel gear 38. Namely, the lock mechanism 48 is configured such that the rotation locked state of the reel 20 with respect to the case 12 is released with the meshing of the reel gear 38 with the drive gear on the drive device side. The release operation member 56 rotates integrally with the reel 20, and a projection 56C provided at a central portion of the release operation member 56 makes low friction sliding contact with a spherical surface shaped projection 52B of the brake member 52 that is prevented from rotating with respect to the case 12.

The recording tape cartridge 10 is equipped with a write-protect section 62 for preventing data from being written to the magnetic tape T. The write-protect section 62 is configured provided with an accidental deletion prevention plug 64 capable of moving by user operation between a permitted position that permits data to be written to the magnetic tape T, and a banned position that bans writing of data to the magnetic tape T. In the present exemplary embodiment the accidental deletion prevention plug 64 is configured at a back left corner portion 12BL of the case 12 so as to adopt the permitted position or the banned position by moving along a back wall 12B. The accidental deletion prevention plug 64 is disposed straddling between the lower case 16 and the upper case 14, so as to be guided by a lower guide wall 68 provided inside the lower case 16 substantially parallel to the back wall 12B and an upper guide wall 66 provided inside the upper case 14 substantially parallel to the back wall 12B.

Security Tag Configuration

The recording tape cartridge 10 described above is imparted with a security function to prevent the recording tape cartridge 10 from being carried out of a specific security area. The security function is chiefly provided by a security tag 70 installed inside the case 12.

While not illustrated in the drawings, the security tag 70 is equipped with a coil section 70A formed with a circular column shaped magnetic core with flanges at the two axial direction end portions and a wire coil wound between the flanges, and a condenser section 70B connected to the coil section 70A. The security tag 70 is accordingly formed with an overall bar shape with its length direction aligned in the axial direction of the security tag 70 (with a shape such as a circular column shape, square column or circular column shape connected to a square column shape).

In the security tag 70 of the present exemplary embodiment, the circular column shaped coil section 70A is connected to the square column shaped condenser section 70B so as to form an overall bar shape. As shown in FIG. 2B, the overall length L in the length direction of the security tag 70 is set sufficiently larger than the maximum separation D between the top plate 14A and the bottom plate 16A of the case 12.

The security tag 70 is configured so as to be capable of transmitting to and receiving from a reception antenna and a transmission antenna (external) provided to gates (not shown in the drawings) of the security area. At the entrances and exits of the security area the gates provided with the reception antenna and the transmission antenna are disposed facing each other. Configuration is made such that when the recording tape cartridge 10 installed with the security tag 70 passes through the gate, radio waves are transmitted and received between the transmission antenna and the reception antenna of the gates and the security tag 70, such that communication is performed.

Security Tag Installation Configuration

Explanation follows regarding the installation of the security tag 70 in the case 12 and the retaining structure employed.

As shown in FIG. 1 and FIG. 2, the security tag 70 is disposed inside a front left corner portion 12FL of the case 12. The corner portion 12FL is a space surrounded by a portion configuring a front wall 12F of the case 12 in the outer peripheral walls 14B, 16B (referred to below simply as the front wall 12F), a portion configuring a left side wall 12L of the case 12 (referred to below simply as the left side wall 12L), a reel area rib 32, and a connection wall 36. Namely, the security tag 70 is disposed in a space to the outside of the reel space 34. The front wall 12F corresponds to one of two sides of the peripheral wall forming the corner portion, and the left side wall 12L corresponds to the other of the two sides of the peripheral wall forming the corner portion.

As shown in FIG. 2A, the security tag 70 is disposed inside the corner portion 12FL along the reel area rib 32 in plan view. Namely, as described above, in plan view of the substantially right angled triangular shaped space surrounded mainly by the front wall 12F, the left side wall 12L and the reel area rib 32, the security tag 70 is disposed along the reel area rib 32 corresponding to the diagonal side of the right angled triangle. Namely, the security tag 70 is disposed such that its length direction is a direction (a direction not parallel to either the front wall 12F or the left side wall 12L) substantially parallel to a straight line approximation (the diagonal of the right angled triangle) of the circular arc profiled reel area rib 32 as viewed from the reel 20 axial direction. In the present exemplary embodiment, the security tag 70 is disposed in a range reaching from the vicinity of the screw boss 15 in the corner portion 12FL to the pocket shaped protrusion 19.

As shown in FIG. 2B, a schematic cross-section taken along line 2B-2B of FIG. 2A, the security tag 70 is disposed along the parting line PL of the upper case 14 and the lower case 16. Namely, the upper portion of the security tag 70 is housed in the upper case 14 and the lower portion of the security tag 70 is housed in the lower case 16, so as to straddle both the top and bottom sides of the parting line PL.

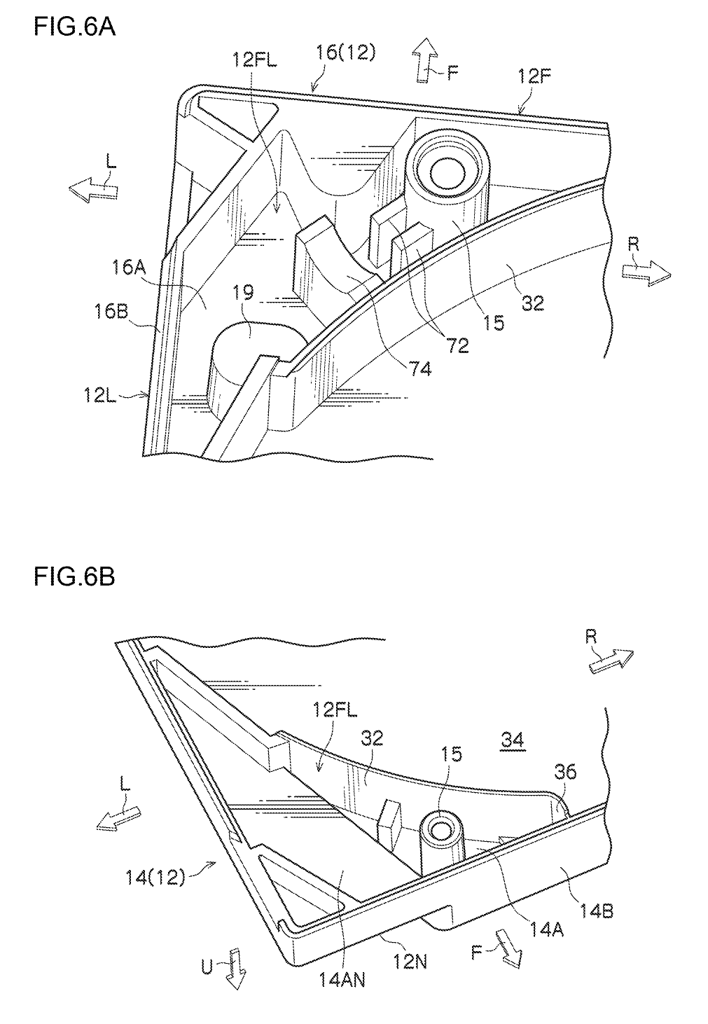

In this state, the security tag 70 is interposed between the top plate 14A of the upper case 14 and the bottom plate 16A of the lower case 16 so as to be retained to the case 12. Specifically, as shown in FIG. 6A, retention ribs 72, 74 serving as configuration portions of the lower case project out from the bottom plate 16A. The retention rib 72 is provided in adjacent contact (contiguous) to the screw boss 15, so as to support the condenser 70B of the security tag 70 from below. The retention rib 74 is provided between the screw boss 15 and the pocket shaped protrusion 19 so as to support the coil section 70A of the security tag 70 from below.

The retention rib 72 has a substantially flat top face corresponding to the square column shaped condenser 70B. The retention rib 74 has a circular arc shaped top face corresponding to the circular column shaped coil section 70A. The security tag 70 is accordingly restricted from moving in a horizontal direction orthogonal to the security tag 70 length direction (axial line). The end portion of the coil section 70A on the opposite side to that of the condenser 70B side is supported from below by the pocket shaped protrusion 19.

The security tag 70 is retained from above and below by the case 12 interposed between the retention rib 72, the retention rib 74 and the pocket shaped protrusion 19 on the lower case 16 side, and the low portion 14AN of the top plate 14A on the upper case 14 side.

Explanation follows regarding operation of the present exemplary embodiment.

The recording tape cartridge 10 configured as described above is loaded into the drive device when data is to be written to the magnetic tape T, or when data written to the magnetic tape T is to be read. The opening 18 is opened as the loading operation is performed, and the drive gear of the rotation shaft is meshed with the reel gear 38 of the reel 20, releasing the rotation lock on the reel 20. The drive device pulls out the magnetic tape T with the leader pin 22 located ahead, and sets the leader pin 22 to a reel inside the drive device. Reading or writing of data is then performed to the magnetic tape T by a head provided partway along a tape path as the reel and the reel 20 are being rotation driven in synchronization with each other.

After completing the reading or writing of data to the magnetic tape T, the reel 20 is rotated in reverse, and the magnetic tape T is wound back onto the reel 20. The leader pin 22 is then retained in the pin receiving indentations 24. The recording tape cartridge 10 is configured such that during the removal operation of the recording tape cartridge 10 from the drive device, the rotation of the reel 20 with respect to the case 12 is locked by the brake member 52, and the opening 18 is closed by the door 28.

When the recording tape cartridge 10 passes through the gates disposed facing each other at an entrance or exit to the security area, radio waves are transmitted and received between the reception antenna and the transmission antenna provided to the gates and the security tag 70. It is thereby detected that the recording tape cartridge 10 has been carried out from the security area. For example, by configuring a system such that a warning noise or the like is emitted from the security area (such as from the gate) when detection has been made whereby psychological pressure is given, theft and accidental take-out (carrying) of the recording tape cartridge 10 can be prevented.

The security tag 70 is disposed along the reel area rib 32 of the corner portion 12FL of the case 12. Namely, the security tag 70 is disposed in the corner portion 12FL formed with a right angled triangle shape in plan view surrounded by the front wall 12F, the left side wall 12L and the reel area rib 32. The security tag 70 is disposed here along the reel area rib 32 corresponding to the diagonal side of the right angled triangle.

A longer security tag 70 can accordingly be installed than a security tag disposed, for example, along the front wall 12F or along the left side wall 12L. In particular, in the recording tape cartridge 10, the security tag 70 is disposed along the parting line PL. A configuration is accordingly realized in which the security tag 70 is disposed inside the case 12 without interfering with the pocket shaped protrusion 19 (the reference hole 19A) and the low portion 14AN (the notch portion 12N) that are required from a functional perspective of the recording tape cartridge 10. In other words, it is configured that a space for installing the security tag 70 is overlapped with the pocket shaped protrusion 19 and the low portion 14AN in plan view in the recording tape cartridge 10, and the long security tag 70 can be disposed therein.

The communication capable distance (an improvement to communication performance) can accordingly be extended with the security tag 70 having a long overall length L in the recording tape cartridge 10. Moreover, the security tag 70 with an overall length L longer than the maximum separation D between the top plate 14A and the bottom plate 16A can be installed in the recording tape cartridge 10. An extension of the communication capable distance (an improvement to communication performance) can accordingly be achieved by the recording tape cartridge 10 in comparison to cases in which a security tag is installed with its length direction orientated parallel to the axial direction of the reel 20.

Additionally, the security tag 70 is disposed along the parting line PL between the upper case 14 and the lower case 16. The installation space for the security tag 70 is accordingly wider than in configurations in which the security tag 70 is disposed at the floor side of the lower case 16 or the upper case 14 (at the bottom plate 16A or the top plate 14A). Namely, the outer peripheral walls 14B, 16B and the reel area rib 32 are set with a draft angle in order to remove the upper case 14 and the lower case 16 from the mold after resin injection molding. The outer peripheral walls 14B, 16B and the reel area rib 32 are therefore configured with a wall thickness thinner on the opening end side, namely the parting line PL side, than on the base side. Therefore, as explained above, the security tag 70 is disposed in the recording tape cartridge 10 in a space in the case 12 that is wider than at the top plate 14A side or the bottom plate 16A side. It is accordingly possible, for example, to make the diameter of the security tag 70 wider, thereby improving the communication performance.

The security tag 70 is disposed along the parting line PL of the upper case 14 and the lower case 16. There is accordingly no need for an operation to insert the security tag 70 deeply to the bottom of the lower case 16 or the upper case 14 (to the bottom plate 16A or the top plate 14A), thereby achieving good operational performance in installation of the security tag 70 in the recording tape cartridge 10.

Furthermore, the recording tape cartridge 10 is a configuration in which the security tag 70 is retained interposed between the upper case 14 and the lower case 16. The security tag 70 can accordingly be retained firmly (such that rattling does not occur) by the case 12 without increasing the number of components. Communication between the security tag 70 and the outside of the case 12 is accordingly stabilized. It is possible to install the security tag 70 that is long in the length direction and the diameter direction since none of the space in the corner portion 12FL is occupied by retaining members.

Explanation follows regarding other exemplary embodiments of the present invention. Components and portions that are basically the same as in the first exemplary embodiment or previously described configurations are allocated the same reference numerals to those of the first exemplary embodiment or the previously described configurations and further explanation thereof is omitted.

### Second Exemplary Embodiment

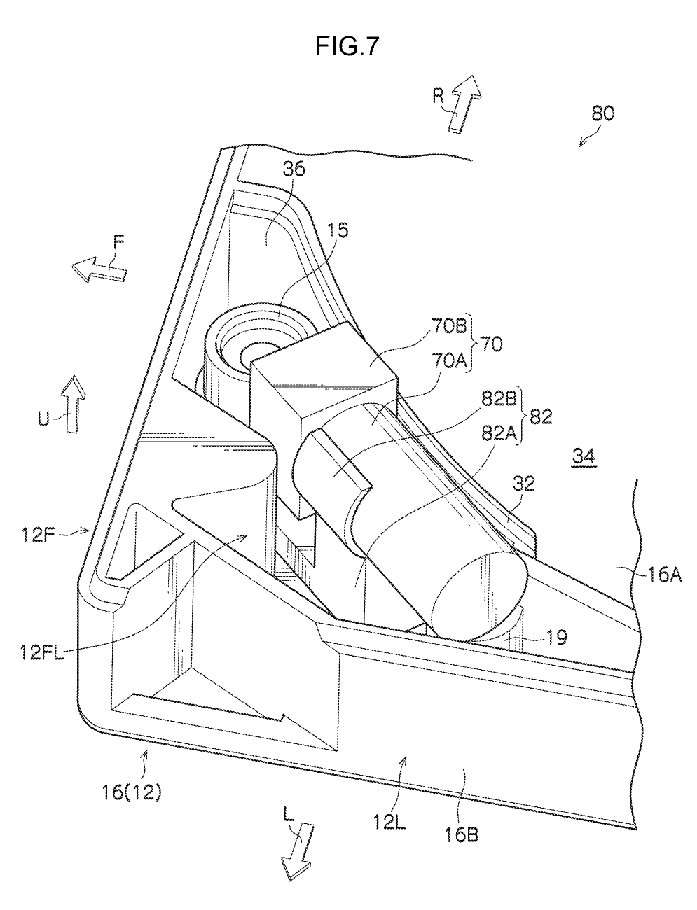

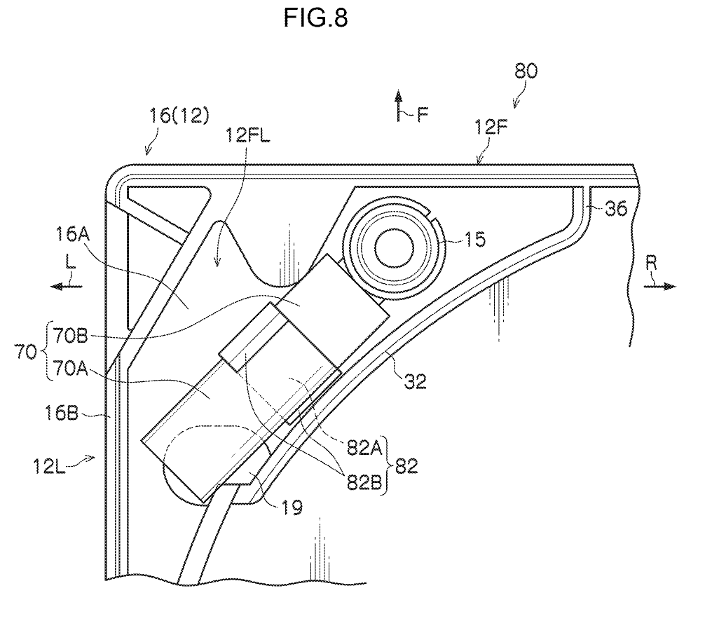

FIG. 7 is a perspective view corresponding to FIG. 1 and illustrates relevant portions of a recording tape cartridge 80 according to a second exemplary embodiment of the present invention. FIG. 8 is a plan view illustrating relevant portions of the recording tape cartridge 80. As shown in these drawings, the recording tape cartridge 80 differs from the recording tape cartridge 10 according to the first exemplary embodiment in the provision of a retaining portion 82 at the lower case 16 for retaining the security tag 70 thereto. The retaining portion 82 serves as a configuration portion of the lower case.

The retaining portion 82 is configured with main portions of a base portion 82A provided extending out from the bottom plate 16A, and a holder portion 82B that is formed at the top end of the base portion 82A. The base portion 82A is disposed between the screw boss 15 and the pocket shaped protrusion 19. The holder portion 82B is configured as a leaf spring having a circular arc shape with a central angle that exceeds 180° and including portions that jut out from the two width direction sides of the base portion 82A. In the present exemplary embodiment, the holder portion 82B is formed with the jutting out portion on the opposite side to that of the reel area rib 32 set longer than the jutting out portion on the reel area rib 32 side.

The retaining portion 82 is configured such that the holder portion 82B resiliently grips the coil section 70A of the security tag 70 (so as to make contact with a region exceeding 180° of the outer periphery of the security tag 70 in a state of resilient deformation). The projection height of the base portion 82A from the bottom plate 16A is set such that the security tag 70 is disposed straddling the parting line PL in a gripped state by the holder portion 82B. A configuration is thereby achieved in which the security tag 70 does not interfere with the pocket shaped protrusion 19 and the low portion 14AN of the top plate 14A. Other portions of the recording tape cartridge 80 including non-illustrated portions are configured similarly to corresponding portions of the recording tape cartridge 10.

The recording tape cartridge 80 of the second exemplary embodiment can accordingly obtain similar advantageous effects to those of the recording tape cartridge 10 of the first exemplary embodiment by having basically the same operation thereto. In the recording tape cartridge 80, the security tag 70 can be held more firmly with the retaining portion 82. Communication between the security tag 70 and the outside of the case 12 is therefore stabilized.

In the second exemplary embodiment, an example has been given in which the security tag 70 is retained by the retaining portion 82 in the case 12, however there is no limitation thereto. For example, the retaining portion 82 can be employed as a temporary retaining member for the security tag 70 during assembly of the recording tape cartridge 80. In such cases, configuration may be made such that the security tag 70 is retained from above and below interposed between the pocket shaped protrusion 19 (and the retention ribs 72, 74) and the low portion 14AN. Configuration may also be made wherein both the interposing retaining structure and the above retaining structure employing the retaining portion 82 are provided in combination.

In the second exemplary embodiment, an example has been given of a case in which the security tag 70 is retained by the lower case 16 with the retaining portion 82 provided at the lower case 16, however there is no limitation thereto. For example, configuration may be made with the retaining portion 82 provided to the upper case 14, and the security tag 70 thus retained by the upper case 14.

### Third Exemplary Embodiment

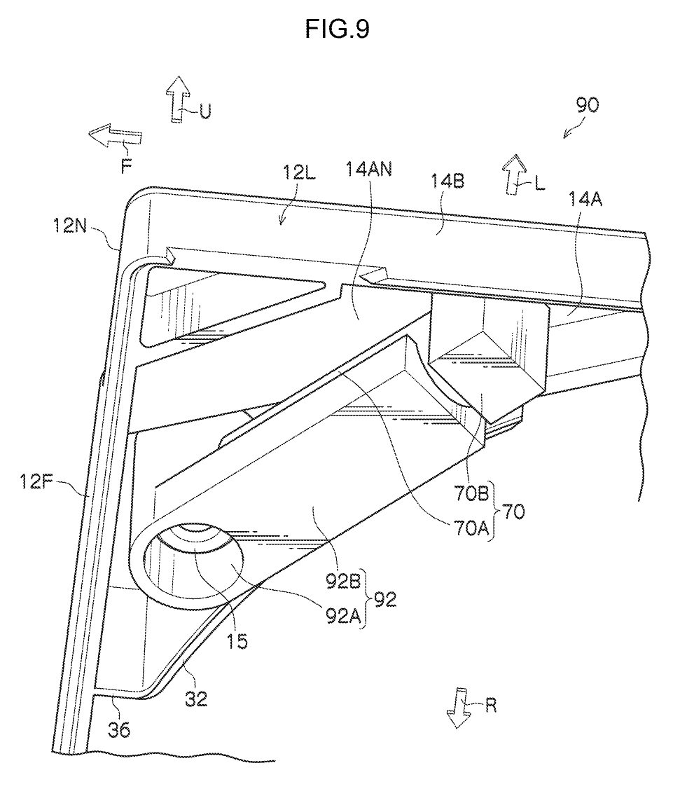

FIG. 9 is a perspective view of relevant portions of a recording tape cartridge 90 according to a third exemplary embodiment of the present invention. As shown in FIG. 9, the recording tape cartridge 90 differs from the recording tape cartridge 10 of the first exemplary embodiment in the provision of a retaining member 92 to retain a security tag 70 on the upper case 14.

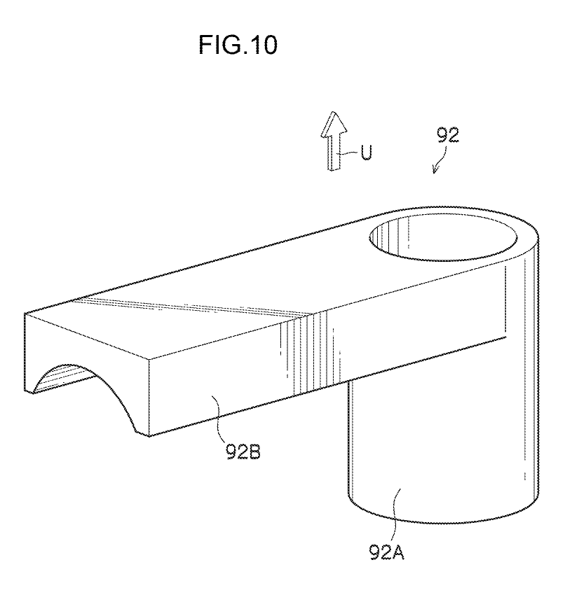

The retaining member 92 is integrally formed with a fitting portion 92A retained by fitting over the screw boss 15 of the upper case 14, and a support portion 92B that juts out from the bottom end of the fitting portion 92A for supporting the coil section 70A from below. As shown in the component diagram of FIG. 10, the support portion 92B of the retaining member 92 has a top face on the coil section 70A side that has a circular arc shape corresponding to the outer periphery of the coil section 70A.

In a state in which the fitting portion 92A is fitted over and retained by the screw boss 15, the retaining member 92 retains the security tag 70 on the case 12 from above and below with the coil section 70A interposed between the support portion 92B and the low portion 14AN. While not illustrated in the drawings, in the retained state, the pocket shaped protrusion 19 is positioned below the support portion 92B.

Note that during assembly of the security tag 70 to the upper case 14, the security tag 70 and the retaining member 92 are assembled to the upper case 14 with the open edge of the upper case 14 facing upwards (the top plate 14A facing downwards). Other portions of the recording tape cartridge 90 are configured similarly to corresponding portions of the recording tape cartridge 10, including not-illustrated portions thereof.

The recording tape cartridge 90 of the third exemplary embodiment can accordingly also obtain similar advantageous effects by having basically the same operation as the recording tape cartridge 10 of the first exemplary embodiment, except for operational effects resulting from the case 12 having a retaining structure for the security tag 70. In the recording tape cartridge 90, there are fewer limitations to the retaining structure as the retaining member 92 that is a separate member to the case 12 is employed, and the security tag 70 can be firmly retained by the case 12. Communication between the security tag 70 and the outside of the case 12 is accordingly stabilized. By employing the retaining member 92 as a separate member to the case 12, the security tag 70 with a long overall length can be installed without making changes to the upper case 14 or the lower case 16.

Note that in the third exemplary embodiment, while an example has been given of a case in which the security tag 70 is retained by the retaining member 92 in the upper case 14, there is no limitation thereto. For example, configuration may be made such that the security tag 70 is retained in the lower case 16 by a retaining member corresponding to the retaining member 92.

In the third exemplary embodiment, an example has been given of a case in which the security tag 70 is retained by the case 12 using the retaining member 92, however there is no limitation thereto. For example, the retaining member 92 can be employed as a temporary retaining member of the security tag 70 during assembly of the recording tape cartridge 90. In such cases, the support portion 92B and the security tag 70 are retained from above and below interposed between the pocket shaped protrusion 19 (and the retention ribs 72, 74) and the low portion 14AN.

Note that whereas in each of the above exemplary embodiments, examples have been given in which the security tag 70 is installed in the corner portion 12FL at the front left of the case 12, there is no limitation thereto. For example, the security tag 70 may be disposed at any corner portion, such as the back left corner portion 12BL or the back right corner portion 12BR (see FIG. 3 and FIG. 4).

1. A recording tape cartridge comprising:
a reel on which magnetic tape is wound;
a case housing the reel between a top plate and a bottom plate that face each other along a reel axial direction, at the inside of a peripheral wall connecting peripheral edge portions of the top plate and the bottom plate;
an inner wall provided so as to extend out from at least one of the bottom plate or the top plate so as to cover the outer periphery of the reel at least at a corner portion of the case; and
a security tag that is equipped with a coil section formed with a circular column shaped magnetic core, a wire coil being wound therearound, and that is disposed in a space surrounded by two sides of the peripheral wall forming the corner portion of the case and the inner wall, such that a length direction of the security tag runs along the inner wall as viewed in the reel axial direction.

2. The recording tape cartridge according to claim 1 wherein:
the case is configured from an upper case, with an upper peripheral wall provided to extend out from a peripheral edge portion of the top plate to configure an upper portion of the peripheral wall, and a lower case, with a lower peripheral wall provided to extend out from a peripheral edge portion of the bottom plate to configure a lower portion of the peripheral wall, by placing the upper peripheral wall and the lower peripheral wall in contact with each other and joining them together; and
the security tag is disposed along the portion where the upper peripheral wall and the lower peripheral wall make contact with each other.

3. The recording tape cartridge of claim 2, wherein a pocket shaped protrusion covering a reference hole open in the bottom plate projects out into the lower case, and the security tag is disposed between the protrusion and the top plate.

4. The recording tape cartridge of claim 2 wherein:
a low portion that forms a bottom portion of an indentation employed to prevent incorrect insertion into a drive device is formed to the top plate of the upper case; and
the security tag is disposed between the low portion and the bottom plate.

5. The recording tape cartridge of claim 1 to further comprising a retaining member that retains the security tag with respect to the case.

6. The recording tape cartridge of claim 2 wherein the security tag is retained with respect to the case by the security tag being interposed in the reel axial direction between a configuration portion of the upper case and a configuration portion of the lower case.

7. The recording tape cartridge of claim 1 wherein a length in a longitudinal direction of the security tag is set longer than the maximum separation in the case along the reel axial direction between the top plate and the bottom plate.
